(19) United States
(12) Patent Application Publication
(10) Pub. No.: US 2023/0087765 A1
(43) Pub. Date: Mar. 23, 2023

(54) AIRBAG TYPE MASSAGE TABLE

(71) Applicant: Jiangsu Mingteng Health Products Co., Ltd, Yancheng (CN)

(72) Inventor: Chuankui Du, Jinshan (CN)

(73) Assignee: Jiangsu Mingteng Health Products Co., Ltd, Yancheng (CN)

(21) Appl. No.: 18/073,588

(22) Filed: Dec. 2, 2022

(30) Foreign Application Priority Data
Sep. 15, 2022 (CN) 202222446553.2

(51) Int. Cl. A61H 9/00

(52) U.S. Cl. CPC A61H 9/0078; A61H 2201/0142; A61H 2203/0456; A61H 2203/0468; A61H 2201/5002; A61H 2201/163; A61H 2201/1621; A61H 2201/5056; A61H 2201/5007; A61H 2201/1238; A61H 2201/5025; A61H 2201/1642

(57) ABSTRACT

The present disclosure relates to an airbag type massage table, and belongs to the technical field of massage apparatuses, including a rigid planner surface, a table top, an upholstery cover, a headrest cushion, and a plurality of airbags. A user can lay in supine or prone position on the table top of the airbag type massage table of the present disclosure. A circuit board is instructed by means of buttons of a controller. The circuit board supplies power to an air pump Air pumps supply air to air valves. Meanwhile, the circuit board controls the opening, closing and air release of the air valves, thus controlling the airbags to be inflated, held and deflated.

### TECHNICAL FIELD

The present disclosure relates to the technical field of massage apparatuses, in particular, to an airbag type massage table.

### BACKGROUND

An existing massage table or massage chair product often uses a mechanical movement, its power often relies on a motor to provide power and conduct power transmission through gears, so that the massager head can rotate, swing or tap, which is complex in structure and prone to mechanical and transmission failures. Users generally complain that the massage strength of such massage product is too high. Moreover, massage tables and massage chairs on the market are usually only suitable for allowing people to lay in a supine position, but these massage tables and massage chairs cannot be used when people lay in a prone position. Meanwhile, their mechanical movements are usually hard, which easily press the muscles and bones of people when not working. As a result, the massage tables or massage chairs on the market cannot be used as ordinary massage tables or ordinary beds for sleep or rest.

### SUMMARY

An embodiment of the present disclosure aims to provide an airbag type massage table and to solve the following shortcomings: A mechanical movement of existing massage tables or massage chairs are prone to failure, hard to repair, has extremely high massage strength, cannot be used when a user lays in prone position, and cannot be used as an ordinary bed or a massage table.

In order to achieve the above objective, the present disclosure provides the following technical solution:

An airbag type massage table includes:

a rigid planner surface;

a table top, fixed on the rigid planner surface;

an upholstery cover, upholstered on the table top, wherein a breath hole is arranged on the table top and upholstery cover corresponding to the position of user's head;

a headrest cushion, mounted on the breath hole on the table top, wherein the headrest cushion can be used to cover the breath hole; and

a plurality of airbags, mounted on the table top, wherein the airbags are respectively arranged at positions corresponding to the neck, back, waist and hips when a user lays in supine position and positions corresponding to the chest, abdomen and lower abdomen when the user lays in prone position.

As a further technical solution of the present disclosure, the airbags at the positions corresponding to the neck, back, waist and hips when user lays in supine position are in a flat state when the airbags are not inflated, and are in a rise state when the airbags are inflated.

As a further technical solution of the present disclosure, hip clamping airbags are respectively arranged on two sides of positions of the table top corresponding to the hips of the user; and the hip clamping airbags clamp user's hips when they are inflated.

As a further technical solution of the present disclosure, chest-abdomen clamping airbags are respectively arranged on two sides of a position of the table top corresponding to the chest-abdomen of the user; and the chest-abdomen clamping airbags clamp user's chest-abdomen when they are inflated.

As a further technical solution of the present disclosure, leg clamping airbags are respectively arranged on the table top corresponding to two sides of user's left leg and two sides of user's right leg; the leg clamping airbags protrude from the table top; and the leg clamping airbags clamp user's legs when they are inflated.

As a further technical solution of the present disclosure, the airbags on the two sides of the position corresponding to the chest of the user, the airbags on the two sides of the positions corresponding to the hips of the user, and the airbags on the two sides corresponding to the left leg and right leg of the user are kept in a certain half-upright or upright inclination angle from the table top.

As a further technical solution of the present disclosure, each airbag is provided with an air inlet and outlet hose; and the plurality of airbags are respectively inflated or deflated through the plurality of air inlet and outlet hoses.

As a further technical solution of the present disclosure, the airbag type massage table further includes:

a plurality of air valves, respectively connected to the plurality of airbags through the plurality of air inlet and outlet hoses; and

air pumps, connected to the air valves through the air inlet and outlet hoses and used for supplying air to the air valves through the air inlet and outlet hoses, and inflating, holding and deflating the airbags by means of opening and closing the air valves and releasing air, thus forming a complete air loop.

As a further technical solution of the present disclosure, the airbag type massage table further includes:

a circuit board, connected to the air pumps and the air valves through wires and used for supplying power to the air pumps and the air valves;

a transformer, connected to an external power supply and used for converting a high voltage of 110-230 V into a safe voltage lower than 36 V and supplying power to the circuit board.

As a further technical solution of the present disclosure, the airbag type massage table further includes:

a controller, connected to the circuit board through a wire, wherein the controller is provided with a button; the buttons are in communication connection with the circuit board through a wire; and

the circuit board is controlled by controlling the buttons.

Compared with the prior art, the present disclosure has the beneficial effects: A user can lay in-supine or prone position on the table top. The circuit board is instructed by means of the buttons of the controller. The circuit board supplies power to the air pumps. The air pumps supply air to the air valves. Meanwhile, the circuit board controls the opening, closing and air release of the air valves, thus controlling the airbags to be inflated, held and deflated. The plurality of airbags are inflated, held and deflated to wave, and the inflated airbags massage the body. In addition, the leg clamping airbags clamp user's leg when they are inflated, and the chest-abdomen clamping airbags clamp user's chest-abdomen when they are inflated, thus massaging the body of the user.

### BRIEF DESCRIPTION OF THE DRAWINGS

FIG. 1 is a flat view of an airbag type massage table;

FIG. 2 is a top view of an airbag type massage table;

FIG. 3 is a three-dimensional diagram of an airbag type massage table;

FIG. 4 is an exploded diagram of an airbag type massage table; and

FIG. 5 is a diagram of uninflated and inflated states of chest-abdomen clamping airbags and hip clamping airbags in an airbag type massage table.

In the drawings: 1: rigid planner surface; 2: table top; 3: airbag; 3-1: chest-abdomen clamping airbag; 3-2: hip clamping airbag; 3-3: leg clamping airbag; 4: upholstery cover; 5: headrest cushion; 6: leg supporting frame; 7: container; 8: transformer; 9: controller; 10: air inlet and outlet hose; 11: supporting leg; 12: circuit board; 13: air pump; and 14: air valve.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

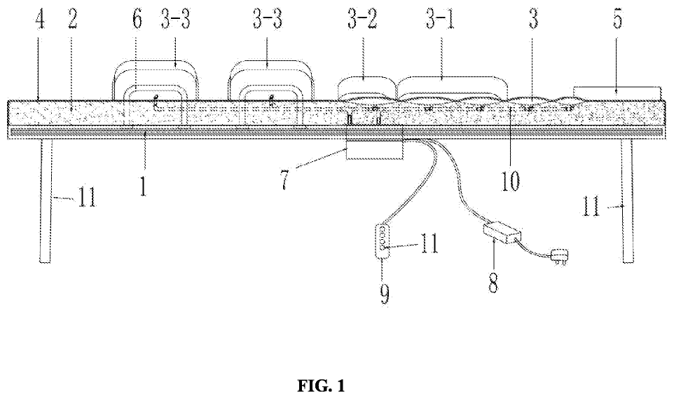

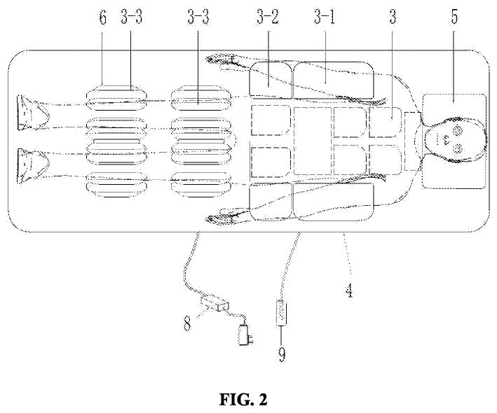

As shown in FIG. 1 to FIG. 4, an airbag type massage table provided according to one embodiment of the present disclosure is illustrated, including a rigid planner surface 1, a table top 2, airbags 3, an upholstery cover 4, a headrest cushion 5, air inlet and outlet hoses 10, and supporting legs 11. The supporting legs 11 are mounted below the rigid planner surface 1. The table top 2 is fixed on the rigid planner surface 1. The soft upholstery cover 4 is upholstered on the table top 2. A breath hole is arranged on the table top 2 and upholstery cover 4 corresponding to the position of user's head. The headrest cushion 5 is arranged above the breath hole. The airbags 3 are fixed below the upholstery cover 4 and above the table top 2. The airbags 3 are arranged at the place corresponding to the neck, back, waist and hips of the user when user lays in supine position, or the place corresponding to the chest, abdomen and lower abdomen of the user when user lays in prone position.

In the present disclosure, when the user lays in supine position, the headrest cushion 5 can be arranged below the user's head as a pillow. When the user lays in prone position, the headrest cushion 5 can be removed, and the nose and eyes of the user can be put in the breath hole.

In the present disclosure, the airbags 3 at the positions corresponding to the neck, back, waist and hips of the user are in a flat state when not inflated, and the airbags 3 rise when inflated. The airbags 3 move up and down in the inflation and deflation processes.

In the embodiment of the present disclosure, the airbags 3 are inflated to rise, so that the upholstery cover 4 rises to massage the neck, back, waist, hips, abdomen, chest, and lower abdomen of the user laying on the massage table.

As shown in FIG. 1 to FIG. 5, in one embodiment of the present disclosure, chest-abdomen clamping airbags 3-1 are respectively arranged at two ends of a position of the table top 2 corresponding to the chest-abdomen of the user. The chest-abdomen clamping airbags 3-1 at the two ends of the chest-abdomen protrude from the table top 2. The chest-abdomen clamping airbags 3-1 are of a multilayer structure. During inflation, the chest-abdomen clamping airbags 3-1 at the two ends of the chest-abdomen of the user respectively move towards the chest-abdomen of the user. When inflated, the chest-abdomen clamping airbags 3-1 clamp the chest-abdomen of the user.

As shown in FIG. 1 to FIG. 5, in one embodiment of the present disclosure, hip clamping airbags 3-2 are respectively arranged on two sides of positions of the table top 2 corresponding to the hips of the user. The hip clamping airbags 3-2 on the two sides of the hips protrude from the table top 2. The hip clamping airbags 3-2 are of a multilayer structure. During inflation, the hip clamping airbags 3-2 on the two sides of the hips of the user respectively move towards the hips of the user. When inflated, the hip clamping airbags 3-2 clamp the hips of the user.

As shown in FIG. 1 to FIG. 4, in one embodiment of the present disclosure, leg clamping airbags 3-3 are respectively arranged on the table top 2 corresponding to two sides of user's left leg and two sides of user's right leg. The leg clamping airbags 3-3 protrude from the table top 2. When inflated, the leg clamping airbags 3-3 on the two sides of the left leg respectively move towards the left leg of the user, and the leg clamping airbags 3-3 on the two sides of the right leg respectively move towards the right leg of the user. When inflated, the leg clamping airbags 3-3 clamp the left leg and right leg of the user.

As shown in FIG. 1 to FIG. 4, the chest-abdomen clamping airbags 3-1 at the two ends of the position corresponding to the chest-abdomen of the user, the hip clamping airbags 3-2 on the two sides of the positions corresponding to the hips of the user, and the leg clamping airbags 3-3 on the two sides corresponding to the left leg and right leg of the user are kept in a half-upright inclination angle from the table top 2.

As shown in FIG. 1 to FIG. 4, each airbag 3, each chest-abdomen clamping airbag 3-1, each hip clamping airbag 3-2 and each leg clamping airbag 3-3 are all provided with the air inlet and outlet hoses 10. The airbags 3, the chest-abdomen clamping airbag 3-1, the hip clamping airbag 3-2 and the leg clamping airbag 3-3 can be inflated or deflated through the air inlet and outlet hoses 10.

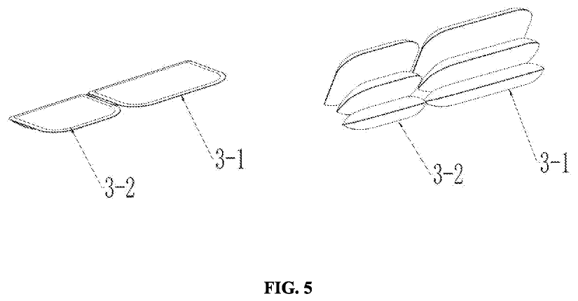

As shown in FIG. 5, the chest-abdomen clamping airbag 3-1 is of a three-layer structure. A bottom layer is a small airbag mounted close to an inner side. A middle layer is medium-sized airbag mounted close to the inner side. An upper layer is a large airbag mounted close to the inner side. When inflated, the chest-abdomen clamping airbag 3-1 spreads and rises in a fan-shaped manner by taking the inner side mounting position as a center to clamp the chest-abdomen from the two sides of the user.

As shown in FIG. 5, the hip clamping airbag 3-2 is of a three-layer structure. A bottom layer is a small airbag mounted close to an inner side. A middle layer is a medium-sized airbag mounted close to the inner side. An upper layer is a large airbag mounted close to the inner side. When inflated, the hip clamping airbag 3-2 spreads and rises in a fan-shaped manner by taking the inner side mounting position as a center to clamp the hips from the two sides of the user.

As shown in FIG. 1 to FIG. 4, the leg supporting frame 6 is fixed to the rigid planner surface 1. The leg supporting frame 6 passes through the table top 2, and the leg supporting frame 6 protrudes from the table top 2. The leg supporting frame 6 includes a left support, a middle support and a right support. An appropriate space is reserved between the left support and the middle support, and an appropriate space is reserved between the right support and the middle support. The left leg and right leg of a user can be placed in the above two spaces.

As shown in FIG. 1 to FIG. 4, the leg clamping airbags 3-3 are mounted against the inner side of the left support and the right support, and both sides of middle support. Each leg clamping airbags 3-3 has a two-layer structure. When inflated, the leg clamping airbags 3-3 spread and rise. The leg supporting frame 6 achieves an effect of supporting the leg clamping airbags 3-3. The leg clamping airbags 3-3 are inflated to respectively clamp the left and right legs of the user.

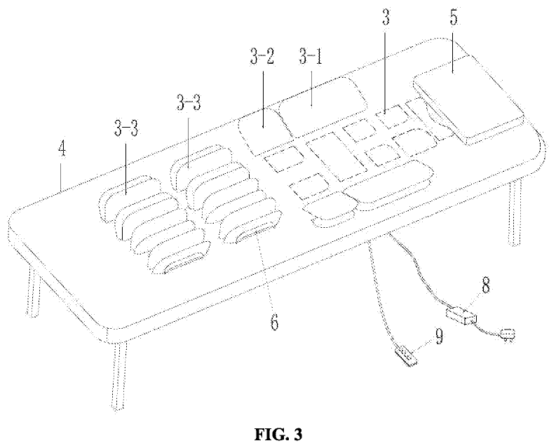

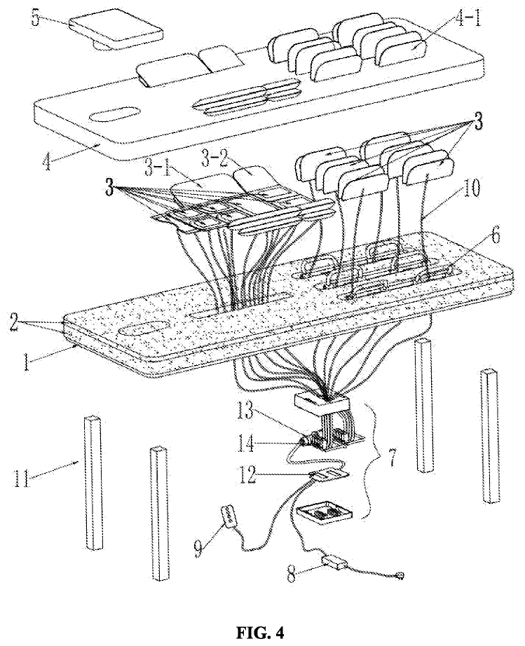

As shown in FIG. 1, FIG. 3, and FIG. 4, the airbag type massage table provided according to one embodiment of the present disclosure further includes a plurality of air valves 14, air pumps 13, a circuit board 12, and a transformer 8. A container 7 is mounted below the rigid planner surface 1. The air valves 14, the air pumps 13 and the circuit board 12 are all mounted in the container 7. The air pumps 13 and the air valves 14 are connected through the air inlet and outlet hoses 10. The air pumps 13 supply air to the plurality of air valves 14 through the air inlet and outlet hoses 10. Each air valve 14 is connected to one or more airbags 3 through the air inlet and outlet hose 10. Air is supplied to and released from the airbags 3, the chest-abdomen clamping airbags 3-1, the hip clamping airbags 3-2 and the leg clamping airbags 3-3 by means of opening and closing the air valves 14 and releasing air, thus forming a complete air loop.

In the present disclosure, when the air pumps 13 are powered on, gas in the air can be sucked, and the gas is supplied to the air valves 14 through the air inlet and outlet hoses 10. The air valves 14 can be electrically controlled to be opened and closed, as well as achieve an air release effect. When the air valves 14 are opened, the gas passes through the air valves 14, and the airbags 3, the chest-abdomen clamping airbags 3-1, the hip clamping airbags 3-2 and the leg clamping airbags 3-3 are inflated through the air inlet and outlet hoses 10, so that the foregoing airbags 3 rise to press the neck, back, waist, hips, abdomen, chest, and lower abdomen of the user, the chest-abdomen clamping airbags 3-1 clamp the chest-abdomen from two sides of the user, the hip clamping airbags 3-2 clamp the hips from two sides of the user, the leg clamping airbags 3-3 clamp the left and right legs of the user. When the air valves 14 are closed, the gas cannot pass through the air valves 14 to enter the airbags 3, the chest-abdomen clamping airbags 3-1, the hip clamping airbags 3-2 and the leg clamping airbags 3-3 are neither inflated nor deflated. When the air valves 14 release air, the gas inside the airbags 3, the chest-abdomen clamping airbags 3-1, the hip clamping airbags 3-2 and the leg clamping airbags 3-3 is discharged through the air valves 14.

As shown in FIG. 1 to FIG. 4, in the embodiment of the present disclosure, the transformer 8 is connected to an external power supply socket, and can convert a high voltage of 110-230 V into a safe voltage lower than 36 V. The transformer 8 is connected with the circuit board 12 through a wire and supplies power to the circuit board 12. The circuit board 12 is connected to the air pumps 13 and the air valves 14 through wires and supplies power to the air pumps 13 and the air valves 14.

As shown in FIG. 1 to FIG. 4, in the embodiment of the present disclosure, the airbag type massage table further includes a controller 9. The controller 9 is connected with the circuit board 12 through a wire. The controller 9 is provided with buttons. The buttons are in communication connection with the circuit board 12 through a wire. The circuit board 12 is controlled by means of controlling the buttons.

In the present disclosure, a working program is pre-stored in the circuit board 12. The circuit board 12 controls, according to the pre-stored program by means of powering on or powering off the air pumps 13 or the air valves 14, the air pumps 13 to pump air or the opening, closing and air release of the air valves 14, thus inflating, holding and deflating the airbags 3.

For those skilled in the art, it is apparent that the present disclosure is not limited to the details of the demonstrative embodiments mentioned above, and that the present disclosure can be realized in other specific forms without departing from the spirit or basic features of the present disclosure. Therefore, from any point of view, the embodiments should be regarded as exemplary and non-limiting. The scope of the present disclosure is defined by the appended claims rather than the above description. Therefore, all changes falling within the meanings and scope of equivalent elements of the claims are intended to be included in the present disclosure. No drawing markings in claims shall be deemed to limit the claims involved.

In addition, it should be understood that although this specification is described in accordance with the implementation modes, and each implementation mode does not only contain one independent technical solution. This narration in the specification is only for clarity. Those skilled in the art should regard the specification as a whole. The technical solutions in all the embodiments can also be appropriately combined to form other implementation modes that can be understood by those skilled in the art.

What is claimed is:

1. An airbag type massage table, comprising:
a rigid planner surface;
a table top, fixed on the rigid planner surface;
an upholstery cover, upholstered on the table top, wherein a breath hole is arranged on the table top and upholstery cover corresponding to the position of user's head;
a headrest cushion, mounted on the breath hole on the table top, wherein the headrest cushion can be used to cover the breath hole; and
a plurality of airbags, mounted on the table top, wherein the plurality of airbags are respectively arranged at positions corresponding to the neck, back, waist and hips when user lays in supine position, abdomen and lower abdomen when user lays in prone position.

2. The airbag type massage table according to claim 1, wherein the airbags at the positions corresponding to the said neck, back, waist and hips of the user are in a flat state when the airbags are not inflated, and a rise state when the airbags are inflated.

3. The airbag type massage table according to claim 1, wherein hip clamping airbags are respectively arranged on two sides of positions of the table top corresponding to the hips of the user; the hip clamping airbags on the two sides of the hips protrude from the table top; when inflated, the hip clamping airbags on the two sides of the hips respectively move towards the hips of the user to clamp the hips of the user.

4. The airbag type massage table according to claim 1, wherein chest-abdomen clamping airbags are respectively arranged on two sides of a position of the table top corresponding to the chest-abdomen of the user; the chest-abdomen clamping airbags protrude from the table top; when inflated, the chest-abdomen clamping airbags on the two sides of the chest-abdomen respectively move towards the chest-abdomen of the user to clamp the chest-abdomen of the user.

5. The airbag type massage table according to claim 1, wherein leg clamping airbags are respectively arranged on the table top corresponding to two sides of user's left leg and two sides of user's right leg; the leg clamping airbags protrude from the table top; when inflated, the leg clamping airbags on the two sides of the left leg respectively move towards the left leg of the user, and the leg clamping airbags on the two sides of the right leg respectively move towards the right leg of the user, to clamp the left leg and right leg of the user.

6. The airbag type massage table according to claim 3, wherein the airbags on the two sides of the position corresponding to the chest of the user, the airbags on the two sides of the positions corresponding to the hips of the user, and the airbags on the two sides corresponding to the left leg and right leg of the user are kept in a certain half-upright or upright inclination angle from the table top.

7. The airbag type massage table according to claim 4, wherein each airbag is provided with an air inlet and outlet hose; and the plurality of airbags are respectively inflated or deflated through the plurality of air inlet and outlet hoses.

8. The airbag type massage table according to claim 1, wherein the airbag type massage table further comprises:
a plurality of air valves, respectively connected to the plurality of airbags through the plurality of air inlet and outlet hoses; and
one or multiple air pumps, connected to the air valves through the air inlet and outlet hoses and used for supplying air to the air valves through the air inlet and outlet hoses, and inflating, holding and deflating the airbags by means of opening and closing the air valves and releasing air, thus forming a complete air loop.

9. The airbag type massage table according to claim 8, wherein the airbag type massage table further comprises:
a circuit board, connected to the air pumps and the air valves through wires and used for supplying power to the air pumps and the air valves;
a transformer, connected to an external power supply and used for converting a high voltage of 110-230 V into a safe voltage lower than 36 V and supplying power to the circuit board.

10. The airbag type massage table according to claim 9, wherein the airbag type massage table further comprises:
a controller, connected to the circuit board through a wire, wherein the controller is provided with buttons; the buttons are in communication connection with the circuit board through a wire; and the circuit board is controlled by controlling the buttons.
